(19) United States
(12) Patent Application Publication
(10) Pub. No.: US 2014/0076689 A1
(43) Pub. Date: Mar. 20, 2014

(54) 4-WAY CROSSED BELT AND AUTOMATIC PARCEL SORTING APPARATUS USING THE SAME, AND SORTING METHOD THEREOF

(71) Applicant: Electronics and Telecommunications Research Institute, Daejeon (KR)

(72) Inventors: Young Won KIM, Daejeon (KR); Dong Gil NA, Daejeon (KR)

(73) Assignee: Electronics and Telecommunications Research Institute, Daejeon (KR)

(21) Appl. No.: 13/958,544

(22) Filed: Aug. 3, 2013

(30) Foreign Application Priority Data
Sep. 17, 2012 (KR) 10-2012-0102678

(51) Int. Cl. B65G 47/53

(52) U.S. Cl. CPC B65G 47/53
USPC 198/370.03; 198/575; 198/570

(57) ABSTRACT

An automatic parcel sorting apparatus and a sorting method thereof that use a 4-way crossed belt instead of a unidirectional or bidirectional crossed belt which is generally used in an automatic parcel sorting apparatus such as an automatic parcel sorting machine.

### CROSS-REFERENCE TO RELATED APPLICATIONS

This application claims priority to and the benefit of Korean Patent Application No. 10-2012-0102678 filed in the Korean Intellectual Property Office on Sep. 17, 2012, the entire contents of which are incorporated herein by reference.

### TECHNICAL FIELD

The present invention relates to an apparatus and a method of sorting sorted objects by using a 4-way crossed belt, and may correspond to a technical field to which for example, a parcel sorting machine (PSM) pertains.

### BACKGROUND

An automatic parcel sorting apparatus which is installed and used generally at present is configured by an oval conveying tray, and as a result, a parcel is broken away and falls or is pushed to a next tray space due to inertia, or the like which are caused by a weight of a parcel and a movement speed of a tray in an oval curved section.

The automatic parcel sorting apparatus requires a large-scale physical installation space in order to install the oval tray.

### SUMMARY

Since a convey structure is circular when a parcel automation apparatus is designed by using an existing unidirectional crossed belt, a large-scale space is required to install an automatic parcel sorting machine.

Meanwhile, a parcel is damaged and missorted due to a phenomenon in which the parcel falls or is pushed to a next tray by inertia, or the like, which are caused by a weight of the parcel and a movement speed of the crossed belt in an oval curved section.

The present invention has been made in an effort to provide an automatic parcel sorting apparatus which has a small limitation in an installation space of a sorting apparatus such as a parcel sorting machine, may be designed to provide a lot of sorting trays, and can solve damage and missorting of a parcel, which occur in an oval curved section, by not an overall structure but a lattice structure.

An exemplary embodiment of the present invention provides a 4-way crossed belt apparatus including: a removable belt which is joinable in upper and lower, and left and right directions; one or more x-direction driving shafts connected with the belt in one direction to rotate the belt; and one or more y-direction driving shafts rotating the belt in a direction perpendicular to the one direction.

An exemplary embodiment of the present invention provides an automatic parcel sorting apparatus using a 4-way crossed belt, including: one or more introduction units input with a sorted object; a reading unit reading address and barcode information of the input sorted object; a control unit determining a movement path of the sorted object in accordance with the read information; a movement unit conveying the sorted object by using the 4-way crossed belt along the movement path determined by the control unit; one or more sorting units sorting a loading position of the conveyed sorted object; and a loading unit storing the sorted object divided by the sorting unit.

Positions or directions of the removable belt provided in the 4-way crossed belt apparatus, which are joined with one or more x-direction driving shafts or y-direction driving shafts, may depend on an electromagnetic control signal.

A rotational direction of the removable belt provided in the 4-way crossed belt apparatus may vary to an ax direction or a y direction depending on the joining positions or directions.

Another exemplary embodiment of the present invention provides an automatic parcel sorting apparatus using a 4-way crossed belt, including: one or more introduction units input with a sorted object; a reading unit reading address and barcode information of the input sorted object; a control unit determining a movement path of the sorted object in accordance with the read information; a movement unit conveying the sorted object by using the 4-way crossed belt along the movement path determined by the control unit; one or more sorting units dividing a loading position of the conveyed sorted object; and a loading unit storing the sorted object divided by the sorting unit.

The movement unit may stop the 4-way crossed belt, and drive the 4-way crossed belt in left and right, and upper and lower directions to convey the sorted object along the movement path.

The movement unit may include a plurality of 4-way crossed belts and the 4-way crossed belts may be connected to each other in a lattice arrangement.

The control unit may determine the movement path by determining a shortest path up to a loading position of the sorted object in the plurality of 4-way crossed belts connected to each other in the lattice arrangement.

The plurality of 4-way crossed belts may be independently driven, and the movement unit may convey the sorted object along the determined movement path by driving the respective 4-way crossed belts.

When the lattice arrangement is configured by m×n (m and n are natural numbers), the movement unit may convey the sorted object through movement paths as many as maximum of m+n by using the plurality of 4-way crossed belts.

The sorting unit sorting the loading position of the moved sorted object may be divided into maximum of m×n.

The moving unit connected in the lattice arrangement may be relocatable in accordance with a design structure of the configured lattice arrangement.

Meanwhile, yet another exemplary embodiment of the present invention provides an automatic parcel sorting method using a 4-way crossed belt, including: introducing a sorted object in at least one of the upper and lower, and left and right directions; reading address and barcode information of the introduced sorted object; controlling a movement path through which the sorted object is conveyed in accordance with the read information; conveying the sorted object by using the 4-way crossed belt along the controlled movement path; dividing and sorting a loading position of the conveyed sorted object; and loading the sorted object.

In the conveying of the sorted object, the sorted object may be conveyed along the movement path by stopping the 4-way crossed belt, and driving the 4-way crossed belt in left and right, and upper and lower directions.

In the conveying of the sorted object, a plurality of crossed belts connected to each other in a lattice arrangement may be used, and the sorted object may be conveyed by independently driving the plurality of 4-way crossed belts.

In the controlling of the movement path, the movement path may be determined by determining a shortest path up to the loading position of the sorted object in the plurality of 4-way crossed belts connected to each other in the lattice arrangement.

According to an automatic parcel sorting apparatus using a 4-way crossed belt in accordance with an exemplary embodiment of the present invention, an automatic parcel sorting apparatus can be installed in accordance with limitations of a space to be installed, a structural change depending on the number of sorting spaces is easily possible, and more sorting spaces than an existing unidirectional crossed belt structure may be designed. In other words, a plurality of 4-way crossed belts is connected and installed in a lattice direction, and as a result, spatial efficiency is higher than an existing structure and a structure can be fluidly relocated in accordance with the number of sorting spaces.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a conceptual diagram of an installation structure and an installation space of an existing automatic parcel sorting machine.

FIG. 2 is a diagram regarding an operating principle of an existing unidirectional or bidirectional crossed belt.

FIG. 3 is a configuration diagram of an automatic parcel sorting apparatus using a 4-way crossed belt according to an exemplary embodiment of the present invention.

FIGS. 4A to 4C are diagrams illustrating the 4-way crossed belt and an operating principle thereof according to the exemplary embodiment of the present invention. FIG. 4A is a diagram illustrating a case in which there is no electromagnetic signal, that is, a case in which the 4-way crossed belt does not operate, and FIG. 4B is a diagram illustrating a case in which the electromagnetic signal is transmitted simultaneously to left and right sides, and left and right-direction belts are coupled to move in left and right directions. FIG. 4C is a diagram illustrating a case in which the electromagnetic signal is transmitted in upper and lower directions, and as a result, upward and lower-direction belts are coupled to move in the upper and lower directions.

FIG. 5 is a diagram illustrating an automatic parcel sorting apparatus including a plurality of 4-way crossed belts according to the exemplary embodiment of the present invention and a diagram expressing a path on which a sorted object moves by using the plurality of 4-way crossed belts.

FIG. 6 is a conceptual diagram, in more detail, expressing a component constituting the automatic parcel sorting apparatus of FIG. 5.

FIG. 7 is a diagram exemplarily expressing various conveyable paths in the automatic parcel sorting apparatus including the plurality of 4-way crossed belts according to the exemplary embodiment of the present invention.

FIGS. 8A to 8C are diagrams exemplarily expressing a lattice structure relocatable in accordance with various design structures in the automatic parcel sorting apparatus including the plurality of 4-way crossed belts according to the exemplary embodiment of the present invention.

FIG. 9 is a flowchart for describing an automatic parcel sorting method using a 4-way cross belt step by step according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings such that those skilled in the art can easily implement the exemplary embodiments. However, the present invention may be implemented in various different forms and the present invention is not limited to exemplary embodiments described below. Parts which are not associated with the description are not illustrated in the drawings in order to clearly describe the present invention and like reference numerals refer to like elements throughout the specification.

Throughout the specification, when a predetermined part “includes” a predetermined component, it is understood that if it is not contrarily described, the part may further include other components and not exclude the other components.

When reference numerals refer to components of each drawing, it is noted that although the same components are illustrated in different drawings, the same components are referred to by the same reference numerals as possible. In describing the present invention, when it is determined that the detailed description of the known art related to the present invention may obscure the gist of the present invention, the detailed description thereof will be omitted.

In describing the components of the present invention, terms such as first, second, A, B, (a), (b), and the like may be used. The terms are used to just distinguish the component from other components and the essence, sequence, or order of the corresponding component is not limited by the terms. When it is described that any component is “connected”, “coupled”, or “linked” to other components, it should be understood that the component may be directly connected or linked to other components, but another component may be “connected”, “coupled”, or “linked” between the respective components.

Hereinafter, a 4-way crossed belt and an automatic parcel sorting apparatus using the 4-way crossed belt according to exemplary embodiments of the present invention will be described with reference to the accompanying drawings.

Meanwhile, an automatic parcel sorting machine (PSM), which is a typical exemplary embodiment in a technical field to which the present invention belongs, will be primarily described for assisting comprehension.

However, the automatic parcel sorting apparatus is not limited to a postal service system and if the same operating principle may be applied to all systems in which a large quantity of objects need to be sorted, it is apparent to those skilled in the art that the present invention may also be applied thereto.

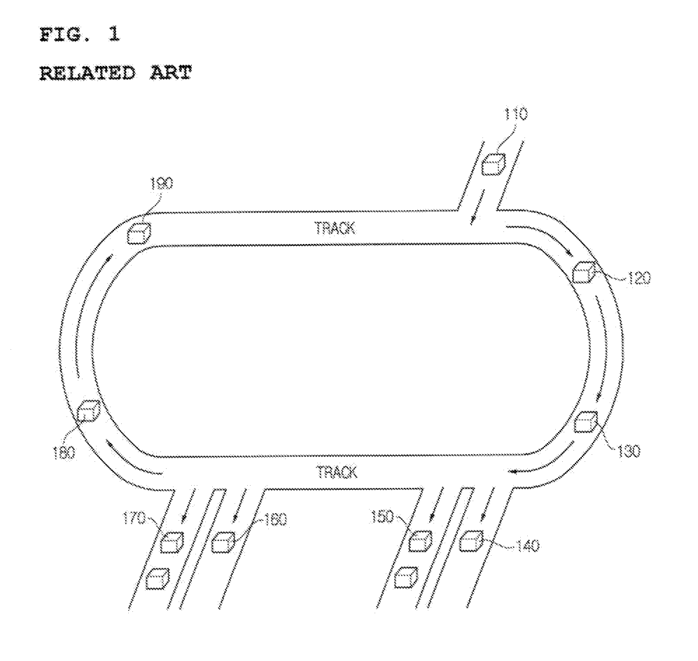

FIG. 1 is a conceptual diagram of an installation structure and an installation space of an existing automatic parcel sorting machine.

An existing automatic parcel sorting machine generally includes a parcel introduction unit, a track formed by a crossed belt having a large overall structure, and a plurality of parcel sorting spaces.

That is, since the automatic parcel sorting machine has an oval structure, a large space is required to install the sorting machine and the existing automatic parcel sorting machine uses a unidirectional or bidirectional crossed belt.

Damage and missorting of a parcel will be described with reference to FIG. 1. When the parcel enters the track through the introduction unit like reference numeral 110, the parcel moves along the track. Since the track has the oval structure, the inertial force, that is, centrifugal force is received due to a weight and a movement speed of the parcel at the same positions as reference numerals 120 and 130 in a curved section and unfortunately, the parcel may be broken away out the track. Parcels to be sorted to respective corresponding sorting spaces may be pushed to next spaces due to the inertia (see reference numerals 140 to 170). Such a phenomenon may be shown similarly in an opposite curved section like reference numerals 180 and 190.

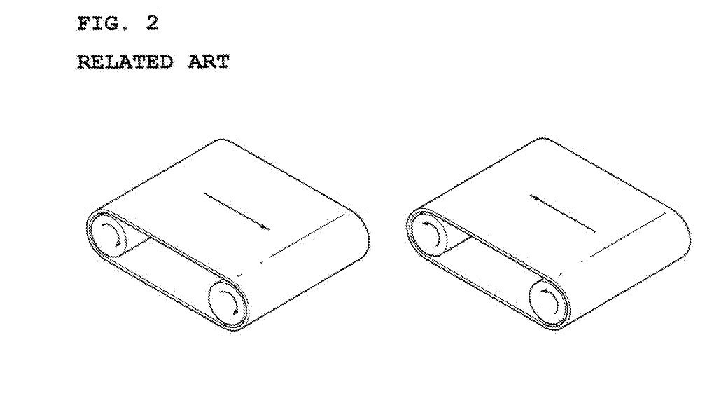

FIG. 2 is a diagram regarding an operating principle of an existing unidirectional or bidirectional crossed belt.

First, the crossed belt mentioned in this specification is just a term indicating a predetermined belt generally used in belt transmission in this specification and is not limited to only a specific type belt as compared with other belt types such as an open belt, and the like.

That is, conceptually, the crossed belt is a concept including all belts which operate in accordance with a principle to transmit power by using friction between belts by winding a belt on two or more belt pulleys and generally means a belt that transfers a rotating motion of one shaft to another shaft by using a belt on pulleys connected to shafts which are parallel to each other. For example, as a belt that transmits rotation by winding the belt on the belt pulleys fixed to both shafts, a flat belt including an open belt (parallel hanging) and a crossed belt (crossed hanging) is used depending on a winding method and a V belt that transmits power between both shafts, which are parallel to each other, by winding a V belt (a ring shaped belt of which a cross section has a trapezoidal shape) is used, and a fiber belt, and the like are primarily used.

Referring to FIG. 2, in the case of the conventional belt, by rotational directions of the parallel shafts, the belt wound therebetween rotates only in one direction (e.g. left) and an opposite direction thereto (e.g. right) to convey an object. Therefore, referring back to FIG. 1, the parcel may be conveyed and sorted only in a clockwise direction or counterclockwise direction of an oval shape in accordance with the operating principle of the conventional belt in the oval parcel sorting machine.

However, the present invention presents a 4-way crossed belt apparatus and an automatic parcel sorting apparatus using the same in which more various combinations and structural designs may be achieved apart from breaking from the conventional method, thereby preventing malfunction fundamentally included in the aforementioned related art. Hereinafter, the 4-way crossed belt apparatus and the automatic parcel sorting apparatus using the same will be described in detail.

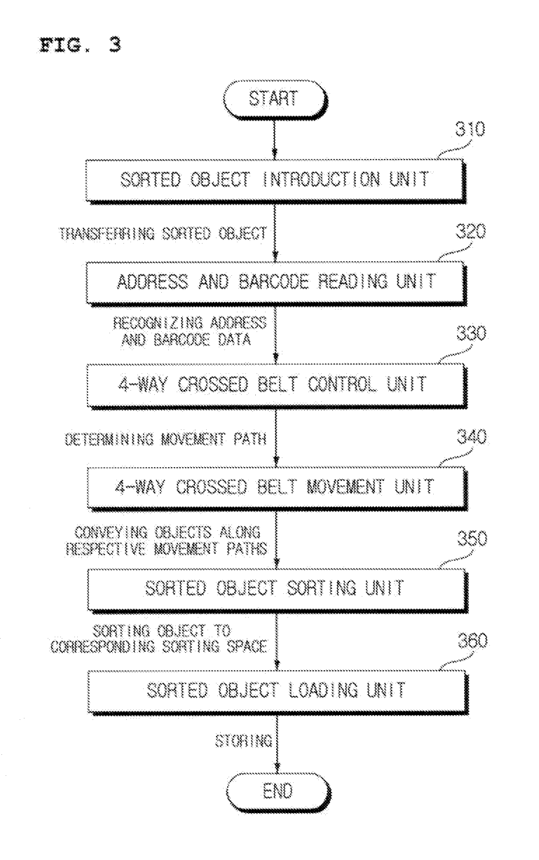

FIG. 3 is a configuration diagram of an automatic parcel sorting apparatus using a 4-way crossed belt according to an exemplary embodiment of the present invention.

Referring to FIG. 3, the automatic parcel sorting apparatus using the 4-way crossed belt according to the present invention may first include one or more introduction units 310 input with a sorted object, a reading unit 320 reading address and barcode information of the sorted object, a control unit 330 determining a movement path of the sorted object in accordance with the read information, a movement unit 340 conveying the sorted object by using the 4-way crossed belt along the movement path determined by the control unit, one or more sorting units 350 dividing a loading position of the conveyed sorted object, and a loading unit 360 storing the sorted object divided by the sorting unit.

Constituent elements constituting the automatic parcel sorting apparatus of the present invention will be described in detail one by one. First, the sorted object introduction unit 310 is a part that inputs, in the sorting apparatus, objects of types required to be sorted, like a large quantity of parcels having a plurality of corresponding destinations.

Herein, an existing unidirectional crossed belt may be used. Of course, the 4-way crossed belt presented in the present invention may also be applied. In this case, the introduction unit and the sorting unit may be compatible with each other because the same type of crossed belt is applied, and as a result, mutual positions and directions of the introduction unit and the sorting unit may be exchanged as necessary.

Meanwhile, the reading unit 320 is provided, which acquires data regarding an address and a barcode by reading the barcode attached to or an address part written on the parcel while the sorted object such as the parcel passes through the introduction unit 310.

Herein, the address may be a delivery destination in the case where the sorted object is the parcel and may be analyzed as addresses in a plurality of categories to be finally sorted in the case where the sorted object is a different type of sorted object other than the parcel.

Next, the address and barcode information acquired and recognized by the address and barcode reading unit 320 are transmitted to the 4-way crossed belt control unit 330. The 4-way crossed belt control unit 330 serves to set a shortest path through which the parcel moves up to the sorting unit (that is, the sorting space), corresponding to the address information and control the 4-way crossed belt movement unit 340 in accordance with the path.

Meanwhile, since the 4-way crossed belt movement unit 340 may be constituted by a plurality of crossed belts, the 4-way crossed belt movement unit 340 may independently control the respective crossed belts. Therefore, the 4-way crossed belt movement unit 340 combines the plurality of crossed belts to calculate and determine a large number of paths and modifies and adjusts, as necessary, driving directions of the respective crossed belts in real time to change an existing movement path.

Next, the 4-way crossed belt movement unit 340 stops the 4-way crossed belt, and drives the 4-way crossed belt in left and right, and upper and lower directions to move an object laid on the belt in four directions.

As described above, the 4-way crossed belt movement unit 340 may include the plurality of crossed belts and in this case, as a connection method, the plurality of crossed belts may be coupled to be arranged in a lattice pattern. Therefore, due to a characteristic of the 4-way crossed belt, since the belt may move in four directions of the left and right, and upper and lower directions unlike the existing crossed belt, an object in a belt group connected in a lattice arrangement may freely move toward a final destination even in any direction.

The object (e.g. parcel), which moves as described above, is divided into respective loading positions through the sorted object sorting unit 350, and stored, that is, loaded through the loading unit 360.

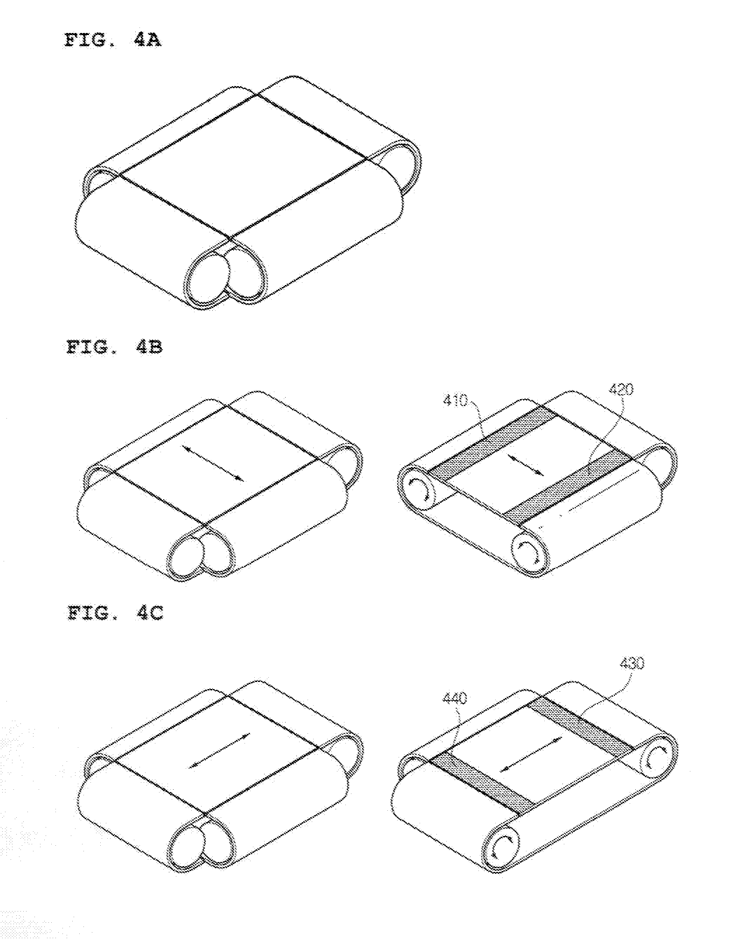

FIGS. 4A to 4C are diagrams illustrating the 4-way crossed belt and an operating principle thereof according to the exemplary embodiment of the present invention.

The 4-way crossed belt apparatus of the present invention includes a removable belt which is joinable in the upper and lower, and left and right directions, and one or more x-direction driving shafts connected with the belt in one direction to rotate the belt and one or more y-direction driving shafts rotating the belt in a direction perpendicular to the one direction.

That is, the 4-way crossed belt apparatus according to the present invention is an apparatus which is joined in a cylindrical shape to move in the upper and lower, and left and right directions only when a divided electromagnetic signal is generated, unlike a cylindrical belt of the existing crossed belt (see FIG. 2) (see FIG. 4A to 4C). For example, a belt cross section of a part where the belt is separated and joined may be made of a material in which a magnetic property is conducted, such as a rubber magnet.

FIG. 4A illustrates a case in which the 4-way crossed belt stops when there is no electromagnetic signal, that is, when the 4-way crossed belt does not operate. FIG. 4B illustrates a case in which the electromagnetic signal is transmitted to both left and right points (that is, 410 and 420) of the belt, and as a result, the left and right-direction belt is coupled with the x-direction driving shaft and then moves in the left and right direction.

Meanwhile, as illustrated in FIG. 4C, the electromagnetic signal is transmitted to upper and lower points (that is, 430 and 440), and as a result, the upper and lower-direction belt is coupled with the y-axis driving shaft to move in the upper and lower directions.

A rotational direction of the removable belt provided in the 4-way crossed belt apparatus may vary in an x direction or a y direction depending on a joined position or direction through an electromagnetic control method.

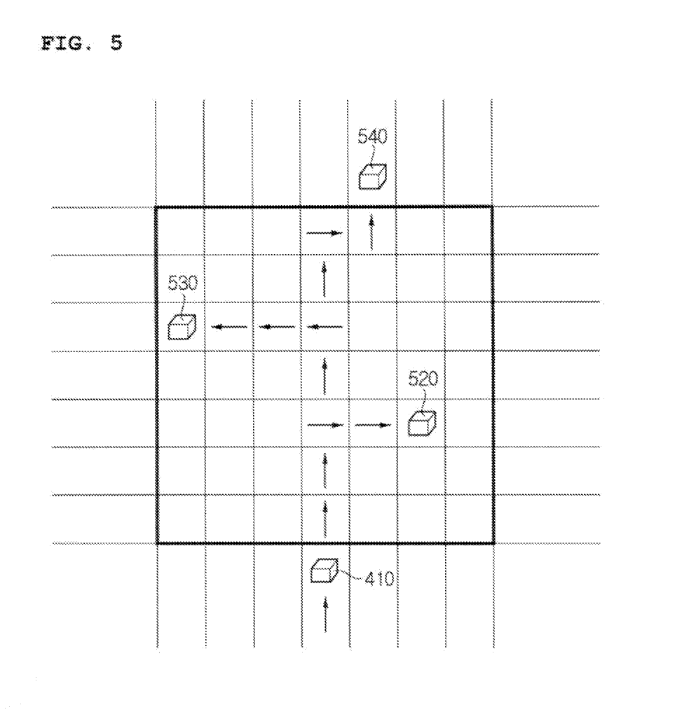

FIG. 5 is a diagram illustrating an automatic parcel sorting apparatus including a plurality of 4-way crossed belts according to the exemplary embodiment of the present invention and a diagram expressing a path on which a sorted object moves by using the plurality of 4-way crossed belts.

Referring to FIG. 5, when it is assumed that the direction of reference numeral 510 is an introduction direction of the object, an object of reference numeral 520, which passes through four 4-way crossed belts in the upper, upper, right, and right directions to be positioned at the present position, is exemplarily illustrated.

Meanwhile, an object of reference numeral 530 passes through seven 4-way crossed belts in the upper, upper, upper, upper, left, left, and left directions to be positioned at the present position.

An object of reference numeral 540 passes through eight 4-way crossed belts in the upper, upper, upper, upper, upper, upper, right, and upper directions to be sorted to a sorting space at the present corresponding position. Therefore, sorting the object of reference numeral 540 is completed.

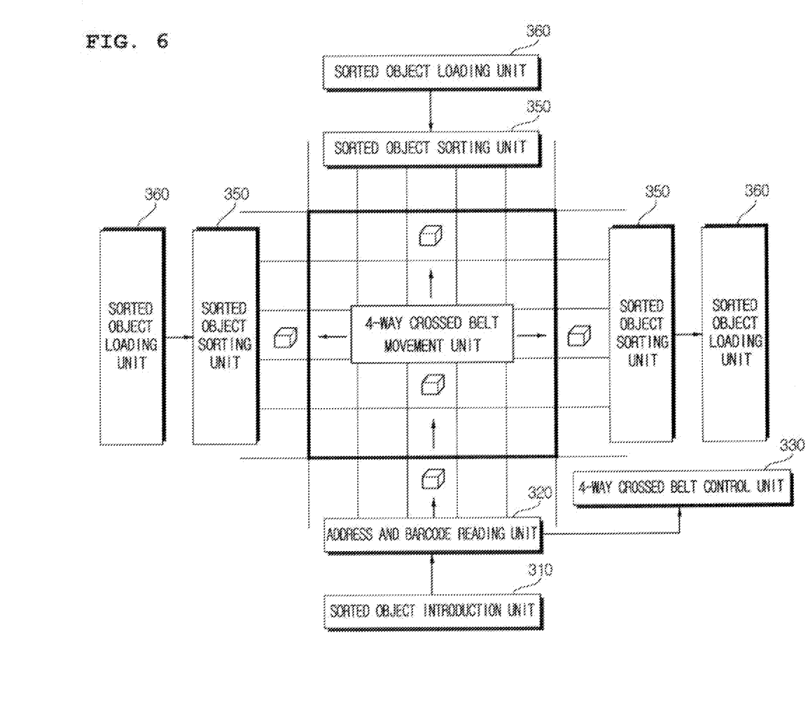

FIG. 6 is a conceptual diagram, in detail, expressing a component constituting the automatic parcel sorting apparatus of FIG. 5.

When the configuration diagram of the automatic parcel sorting apparatus described above (see FIG. 3) is applied to the automatic parcel sorting apparatus having a lattice structure of FIG. 5, the configuration diagram may be expressed like the conceptual diagram of FIG. 6.

That is, barcodes attached to or address parts written on objects such as a large quantity of parcels input through the sorted object introduction unit 310 are read by the address and barcode reading unit 320. The address and barcode information acquired and recognized by the address and barcode reading unit 320 are transmitted to the 4-way crossed belt control unit 330, and the 4-way crossed belt control unit 330 determines a shortest path through which the parcel moves to a sorting space corresponding to the read address information, and thereafter, controls the 4-way crossed belt movement unit 340 in accordance with the path. Thereafter, the 4-way crossed belt movement unit 340 drives the plurality of respective crossed belts in the upper and lower, and left and right directions to move the parcel laid on the belt in the upper and lower, and left and right directions. As such, the driving directions of the respective crossed belts are combined to convey the parcel along the movement path with the shortest path determined by the control unit 330.

The parcel conveyed as such is divided and sorted to respective loading positions through the plurality of sorted object sorting units 350 marked in the upper, left, and right directions of FIG. 6, and loaded through the loading unit 360.

Herein, the introduction unit 310 may also be provided in plural and in this case, the address and barcode reading unit 320 may also be provided in plural. At this time, the 4-way crossed belt control unit 330 calculates movement paths of various parcels input through a plurality of entering passages, respectively, and needs to control the parcels so as not to collide with each other in the movement unit 340. That is, the control unit 330 may calculate and determine numerous paths by using the plurality of crossed belts and stop, as necessary, the respective crossed belts, and modify and adjust the driving directions of the respective crossed belts to the left and right, and upper and lower directions, in real time, to allow the parcels to be sorted to sorting spaces corresponding to addresses of the parcels without causing a collision while the parcels move.

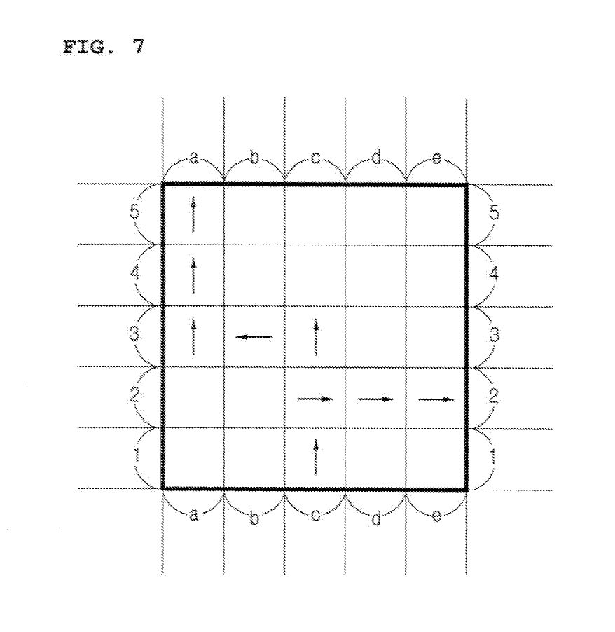

FIG. 7 is a diagram exemplarily expressing various conveyable paths in the automatic parcel sorting apparatus including the plurality of 4-way crossed belts according to the exemplary embodiment of the present invention.

The 4-way crossed belt control unit 330 described above basically calculates and determines the shortest path up to a predetermined loading position of the parcel in order to determine the movement path, but since the 4-way crossed belt control unit 330 needs to prevent the collision of the parcels which are moving in the case where a lot of parcels are input all at once and needs to control conveyance efficiency to time to be increased by increasing the share rate of the crossed belts (that is, a ratio of the number of crossed belts, which are conveying the parcels at present, to the number of all crossed belts), the movement paths of the respective parcels may be differently calculated or modified while the parcels are being conveyed.

An example of the shortest path will be described below with reference to FIG. 7. When a parcel input into lower side c needs to be sorted to right side 2, the movement path may be c1-c2-d2-e2 and may be one of the shortest paths. Meanwhile, similarly, when the parcel input to lower side c needs to be sorted to upper side a, one of the shortest movement paths may be c1-c2-c3-b3-a3-a4-a5.

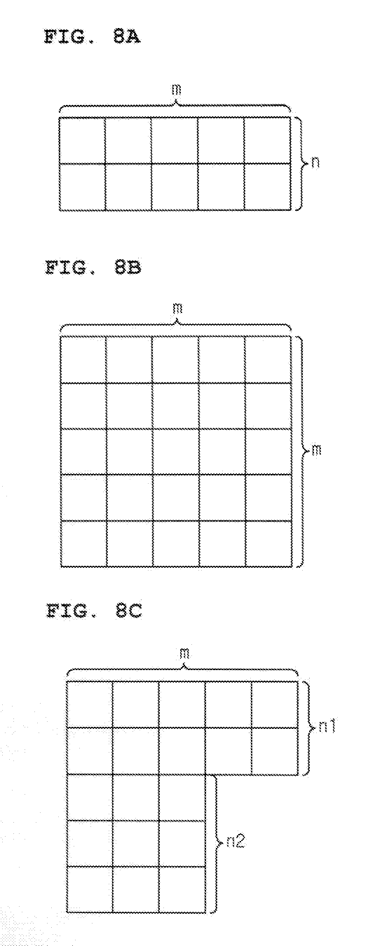

FIGS. 8A to 8C are diagrams exemplarily expressing a lattice structure which is relocatable in accordance with various design structures in the automatic parcel sorting apparatus including the plurality of 4-way crossed belts according to the exemplary embodiment of the present invention.

Referring to FIGS. 8A, 8B, and 8C, when a lattice arrangement is configured by m×n (herein, m and n are a natural number) by using the plurality of 4-way crossed belts, a maximum number of paths through which the parcel is movable in the 4-way crossed belt movement unit 340 becomes m+n (herein, n=n1+n2).

Meanwhile, the number of sorting spaces divided in accordance with addresses may be divided up to maximum of m×n.

The movement unit 340 in which the 4-way crossed belts are connected in the lattice arrangement is relocatable in various shapes in accordance with a design structure of the configured lattice arrangement.

Accordingly, by connecting and installing the 4-way crossed belts in a lattice direction, spatial efficiency is higher than the existing structure and the structure may be designed in accordance with the number of sorting spaces.

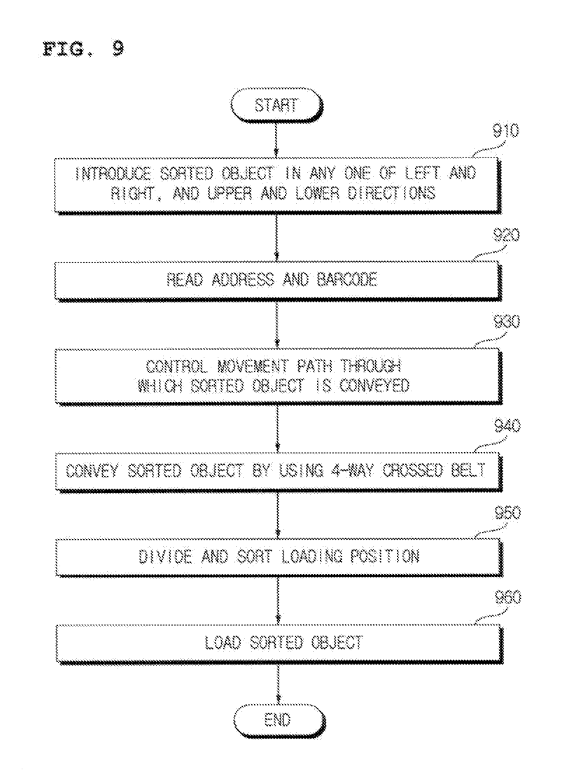

FIG. 9 is a flowchart for describing an automatic parcel sorting method using a 4-way cross belt step by step according to another exemplary embodiment of the present invention.

An automatic parcel sorting method using a 4-way crossed belt according to the present invention may include: introducing a sorted object in at least one direction of upper and lower, and left and right directions (910); reading address and barcode information of the introduced sorted object (920); controlling a movement path through which the sorted object is conveyed in accordance with the read information (930); conveying the sorted object by using the 4-way crossed belt along the controlled movement path (940); dividing and sorting a loading position of the conveyed sorted object (950); and loading the sorted object (960).

Herein, in the conveying of the sorted object (940), the 4-way crossed belt stops, and is driven in the left and right, and upper and lower directions to convey the sorted object along the movement path determined by the control unit 330.

Meanwhile, in the conveying of the sorted object (940), a plurality of 4-way crossed belts connected to each other in a lattice arrangement may be used and the sorted object may be conveyed by independently driving the plurality of 4-way crossed belts.

In the controlling of the movement path (930), the movement path may be determined by judging a shortest path or an optimal path from the plurality of 4-way crossed belts connected in the lattice arrangement up to the loading position of the sorted object.

According to the present invention, an automatic parcel sorting apparatus may be installed in accordance with limitations of an actual physical space where the automatic parcel sorting apparatus is to be installed, a structural change depending on the number of sorting spaces is easily possible, and more sorting spaces than an existing unidirectional crossed belt structure may be designed. In other words, a plurality of 4-way crossed belts are connected and installed in a lattice direction, and as a result, spatial efficiency is higher than an existing structure and a structure of the sorting apparatus may be fluidly relocated in accordance with the number of sorting spaces.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital, versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A 4-way crossed belt apparatus comprising:
a removable belt which is joinable in upper and lower, and left and right directions;
one or more x-direction driving shafts connected with the belt in one direction to rotate the belt; and
one or more y-direction driving shafts rotating the belt in a direction perpendicular to the one direction.

2. The apparatus of claim 1, wherein positions or directions of the removable belt provided in the 4-way crossed belt apparatus, which are joined with the one or more x-direction driving shafts or y-direction driving shafts, depend on an electromagnetic control signal.

3. The apparatus of claim 2, wherein a rotational direction of the removable belt provided in the 4-way crossed belt apparatus varies in an x direction or a y direction depending on the joining positions or directions.

4. An automatic parcel sorting apparatus using a 4-way crossed belt, the apparatus comprising:
one or more introduction units input with a sorted object;
a reading unit reading address and barcode information of the input sorted object;
a control unit determining a movement path of the sorted object in accordance with the read information;
a movement unit conveying the sorted object by using the 4-way crossed belt along the movement path determined by the control unit;
one or more sorting units dividing a loading position of the conveyed sorted object; and
a loading unit storing the sorted object divided by the sorting unit.

5. The apparatus of claim 4, wherein the movement unit stops the 4-way crossed belt, and drives the 4-way crossed belt in left and right, and upper and lower directions to convey the sorted object along the movement path.

6. The apparatus of claim 5, wherein the movement unit includes a plurality of 4-way crossed belts and the 4-way crossed belts are connected to each other in a lattice arrangement.

7. The apparatus of claim 6, wherein the control unit determines the movement path by determining a shortest path up to a loading position of the sorted object in the plurality of 4-way crossed belts connected to each other in the lattice arrangement.

8. The apparatus of claim 7, wherein the plurality of 4-way crossed belts are independently driven, and the movement unit conveys the sorted object along the determined movement path by driving the respective 4-way crossed belts.

9. The apparatus of claim 8, wherein when the lattice arrangement is configured by m×n (m and n are natural numbers), the movement unit is capable of conveying the sorted object through movement paths as many as maximum of m+n by using the plurality of 4-way crossed belts.

10. The apparatus of claim 9, wherein the sorting unit dividing the loading position of the moved sorted object is capable of being divided into maximum of m×n.

11. The apparatus of claim 6, wherein the moving unit connected in the lattice arrangement is relocatable in accordance with a design structure of the configured lattice arrangement.

12. An automatic parcel sorting method using a 4-way crossed belt, the method comprising:
introducing a sorted object in at least one of the upper and lower, and left and right directions;
reading address and barcode information of the introduced sorted object;
controlling a movement path through which the sorted object is conveyed in accordance with the read information;
conveying the sorted object by using the 4-way crossed belt along the controlled movement path;
dividing and sorting a loading position of the conveyed sorted object; and
loading the sorted object.

13. The method of claim 12, wherein in the conveying of the sorted object, the sorted object is conveyed along the movement path by stopping the 4-way crossed belt, and driving the 4-way crossed belt in left and right, and upper and lower directions.

14. The method of claim 13, wherein in the conveying of the sorted object, a plurality of crossed belts connected to each other in a lattice arrangement is used, and the sorted object is conveyed by independently driving the plurality of 4-way crossed belts.

15. The method of claim 14, wherein in the controlling of the movement path, the movement path is determined by determining a shortest path up to the loading position of the sorted object in the plurality of 4-way crossed belts connected to each other in the lattice arrangement.
